(19) United States
(12) Patent Application Publication
(10) Pub. No.: US 2013/0250837 A1
(43) Pub. Date: Sep. 26, 2013

(54) WIRELESS COMMUNICATION METHOD AND WIRELESS COMMUNICATION SYSTEM

(71) Applicant: Yoshimitsu SHIOTANI, Kanagawa (JP)

(72) Inventor: Yoshimitsu SHIOTANI, Kanagawa (JP)

(73) Assignee: RICOH COMPANY. LTD., Tokyo (JP)

(21) Appl. No.: 13/845,632

(22) Filed: Mar. 18, 2013

(30) Foreign Application Priority Data
Mar. 21, 2012 (JP) 2012-063213

(51) Int. Cl. H04W 4/06

(52) U.S. Cl. CPC H04W 4/06
USPC 370/312

(57) ABSTRACT

In a wireless communication method, a wireless communication device on a transmission side transmits a multicast frame to a plurality of wireless communication devices on a reception side in a wireless communication network including the wireless communication devices. The wireless communication method includes: transmitting beacon frames in order by the wireless communication devices; burst-transferring a plurality of multicast frames by the wireless communication device on the transmission side; and transmitting a response frame containing information that indicates whether each of the multicast frames is successfully received, in the order in which the beacon frames are transmitted, by the wireless communication devices on the reception side.

### CROSS-REFERENCE TO RELATED APPLICATIONS

The present application claims priority to and incorporates by reference the entire contents of Japanese Patent Application No. 2012-063213 filed in Japan on Mar. 21, 2012.

### BACKGROUND OF THE INVENTION

1. Field of the Invention

The present invention relates to a wireless communication method and a wireless communication system that execute multicast transfer in a wireless communication network that communicates using time division multiple access (TDMA).

2. Description of the Related Art

In recent years, many wired networks have been replaced by wireless networks. Demand for wireless communication technology is expected to further increase in the future. A dramatic increase in wireless communication speed has enabled wireless communication of a large volume of moving image and audio data, which requires real-time transmission. In an increasing number of situations, a home wireless network connecting domestic electronic devices via a wireless network is established, and a plurality of notebook personal computers (PC) and projectors are wirelessly communicated in meeting rooms at a company office.

Typically in a wireless communication network connecting a plurality of wireless communication devices, once successfully receiving a data frame, the receiving station transmits an acknowledge (ACK) frame to a transmitting station. When receiving the ACK frame, the transmitting station confirms a successful transmission of the data frame and completes the transmission. In a case where the ACK frame is not received within a certain period, the transmitting station determines that the data frame has not been successfully transmitted, and transmits the data frame again. Retransmission of the data frame is repeated until the ACK frame is received or the number of retransmissions reaches a predetermined number. This approach is called an automatic repeat request (ARQ) and improves reliability of the wireless communication. Alternatively, retransmission may be repeated until a lifetime period of the data frame is over.

According to a typical wireless communication standard, however, the ARQ approach is only applied in unicast communication between a single transmitting station and a single receiving station, but not applied to multicast communication between a single transmitting station and each of a plurality of receiving stations. The multicast communication is used, for example, in a case where handouts are transmitted to a plurality of notebook PCs in a meeting room at a time, or a presentation file is transmitted to a plurality of projector devices from a notebook PC at a time. The transmitting station cannot, however, determine whether all of the receiving stations have successfully received those data.

To solve the above problem, various methods have been disclosed. For example, Japanese Patent Application Laid- Open No. 2008-17306 discloses a wireless communication method to improve reliability of the multicast transfer in which a wireless communication device that receives multicast frames transmits ACK frames corresponding to all of the previously received multicast frames all together at a previously specified transmission time of the ACK frames.

Japanese Patent Application Laid-Open No. 2005-236923 discloses a wireless packet communication method to improve reliability of the multicast transfer in which the transmitting station burst-transfers a series of multicast frames and the receiving station performs carrier sensing after receiving the series of multicast frames. If a wireless band is available, the receiving station transmits an acknowledge (ACK) frame including a successful reception list that contains sequence numbers of successfully received multicast frames, or transmits a negative acknowledge (NACK) frame including a non-reception list that contains sequence numbers of multicast frames not received.

There is a need to improve reliability of multicast transfer without reducing throughput and enable fast transfer in a wireless communication network including a plurality of wireless communication devices.

### SUMMARY OF THE INVENTION

It is an object of the present invention to at least partially solve the problems in the conventional technology.

In a wireless communication method, a wireless communication device on a transmission side transmits a multicast frame to a plurality of wireless communication devices on a reception side in a wireless communication network including the wireless communication devices. The wireless communication method includes: transmitting beacon frames in order by the wireless communication devices; burst-transferring a plurality of multicast frames by the wireless communication device on the transmission side; and transmitting a response frame containing information that indicates whether each of the multicast frames is successfully received, in the order in which the beacon frames are transmitted, by the wireless communication devices on the reception side.

A wireless communication system includes a plurality of wireless communication devices. In the wireless communication system, a wireless communication device on a transmission side is capable of transmitting a multicast frame to a plurality of wireless communication devices on a reception side. The wireless communication system includes: units that are each included in one of the wireless communication devices and each transmit a beacon frame; units that are each included in one of the wireless communication devices and each acquire information indicating order in which the wireless communication devices transmits the beacon frame; a unit that is included in the wireless communication device on the transmission side and burst-transfers a plurality of multicast frames; and units that are each included in one of the wireless communication devices on the reception side and transmit response frames each containing information indicating whether each of the multicast frames is successfully received, in the order in which the beacon frames are transmitted.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating a configuration of a wireless communication system according to an embodiment of the present invention;

FIG. 2 is a block diagram of a wireless communication device in FIG. 1;

FIG. 3 is a diagram illustrating a format of a MAC header of a WiMedia-MAC frame;

FIG. 4 is a diagram illustrating a format of a back frame;

FIG. 5 is a diagram illustrating a configuration of a super frame defined by a WiMedia-MAC standard;

FIG. 6 is a timing chart illustrating an example of an operation of burst-transferring multicast frames, in the wireless communication system according to the embodiment of the present invention;

FIG. 7 is a timing chart illustrating another example of the operation of burst-transferring the multicast frames in the wireless communication system according to the embodiment of the present invention;

FIG. 8 is a diagram illustrating an example of a processing flow of a transmitting station in the wireless communication system according to the embodiment of the present invention;

FIG. 9 is a diagram illustrating a processing flow of generation of retransmission frame in FIG. 8; and

FIG. 10 is a diagram illustrating an example of a processing flow of a receiving station in the wireless communication system according to the embodiment of the present invention.

### DETAILED DESCRIPTION OF THE PREFERRED EMBODIMENTS

Hereinafter, an embodiment of the present invention will be described with reference to the drawings.

Configuration of Wireless Communication System

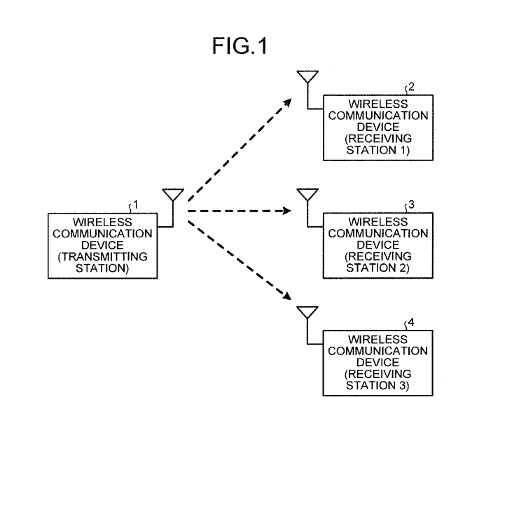

FIG. 1 is a diagram illustrating a configuration of a wireless communication system according to the embodiment of the present invention.

The wireless communication system includes one wireless communication device 1 serving as a transmitting station (transmission side) and three wireless communication devices 2, 3, and 4 serving as receiving stations (reception side). The wireless communication device 1 multicast-transfers multicast frames to the wireless communication devices 2, 3, and 4.

Configuration of Wireless Communication Device

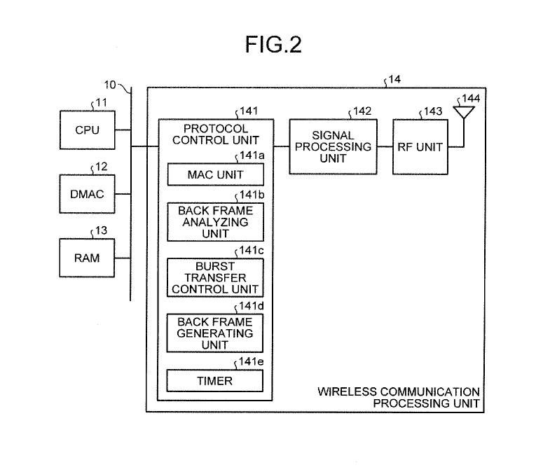

FIG. 2 is a block diagram of the wireless communication device in FIG. 1. The wireless communication devices in FIG. 1 all have the same configuration and thus can serve as the transmitting stations or the receiving stations. The configuration illustrated in FIG. 2 is only an example, and different configurations may be adopted as long as they implement functions of the present invention.

As illustrated in FIG. 2, the wireless communication device includes a central processing unit (CPU) 11, a direct memory access (DMA) controller 12, a random access memory (RAM) 13, and a wireless communication processing unit 14, which are mutually connected via a data transfer bus 10.

The wireless communication processing unit 14 includes a protocol control unit 141, a signal processing unit 142 connected to the protocol control unit 141, a radio frequency (RF) unit 143 connected to the signal processing unit 142, and an antenna 144 connected to the RF unit 143.

The RAM 13 stores therein computer programs executed by the CPU 11 or stores DMA transfer data transferred by the DMAC 12. The DMAC 12 performs DMA transfer between the RAM 13 and a MAC unit 141a in the protocol control unit 141. The protocol control unit 141 controls a wireless communication protocol. The signal processing unit 142 modulates or demodulates transmission and reception frames. The RF unit 143 converts the transmission frames into radio waves to be transmitted from the antenna 144 and extracts the reception frames from the radio waves received by the antenna 144.

The protocol control unit 141 includes the media access control (MAC) unit 141a, a back frame analyzing unit 141b, a burst transfer control unit 141c, a back frame generating unit 141d, and a timer 141e.

The MAC unit 141a performs media access control. The back frame analyzing unit 141b receives back frames from a plurality of wireless communication devices serving as transmitting stations, and determines which data to be retransmitted in which frame, a unicast frame or a multicast frame. The burst transfer control unit 141c calculates from the received back frames the number of transmission frames to be in the next burst transfer, from which the number of retransmission frames is subtracted to generate information containing the number of frames to be newly transmitted. The back frame generating unit 141d generates a bitmap value that represents a reception result of a plurality of frames transmitted to the wireless communication device including that back frame generating unit 141d, calculates a frame size and the number of frames receivable in the next burst transfer sequence, and sets those data to a back frame. The timer 141e determines transmission and reception timings of the frames and, for example, generates information containing a time of transmitting the back frame.

MAC Header Format

Hereinafter, the embodiment will be described by taking as an example a WiMedia-MAC protocol that uses a TDMA communication protocol. The WiMedia-MAC protocol is a MAC protocol standardized by the WiMedia Alliance. The present invention is, however, not limited to the WiMedia-MAC but also applicable to a protocol for a wireless LAN, for example.

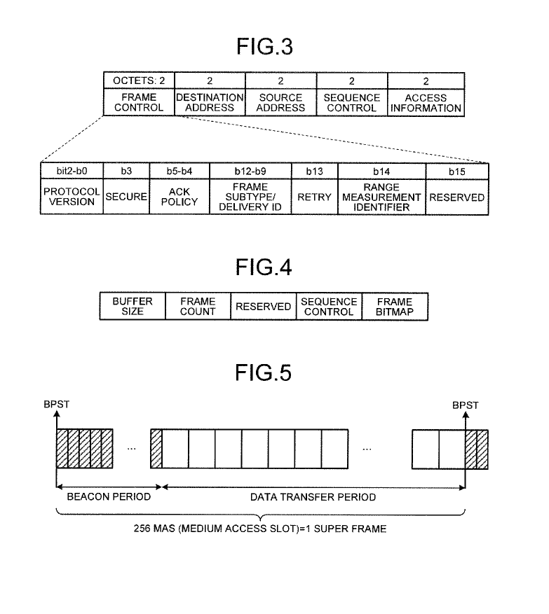

FIG. 3 is a diagram illustrating a MAC header format of a WiMedia-MAC frame. Only a field needed for description of the embodiment will be described herein. ACK policy in a frame control field can be set with four policies; NO-ACK, IMM-ACK, BACK-REQ, and BACK. NO-ACK indicates that the frame does not require an ACK frame, and IMM-ACK indicates that the frame requires an ACK frame. BACK-REQ indicates that a back frame is requested, and BACK indicates that the frame requires a back frame. BACK-REQ is set in the last frame of the burst transfer, and BACK is set in other transmission frames. NO-ACK is set as ACK policy of the back frame.

Back Frame Format

FIG. 4 is a diagram illustrating a back frame format. This format is defined by a WiMedia-MAC standard. Buffer size refers to the sum of frame sizes receivable in the next burst transfer sequence. Frame count refers to the number of frames receivable in the next burst transfer sequence. Frame bitmap is a bitmap value that indicates whether reception of a frame specified with a sequence number indicated by a value in the sequence control field of the MAC header has been successful.

Configuration of Super Frame

FIG. 5 is a diagram illustrating a configuration of a super frame defined by the WiMedia-MAC standard. The WiMedia-MAC uses a TDMA communication protocol to divide one super frame into 256 medium access slots (MASS), which are time slots. The super frame includes a beacon period starting at beacon period start time (BPST) that indicates a starting point thereof, and a data transfer period subsequent to the beacon period.

Each of the wireless communication devices constituting a multicast wireless communication network notifies, using a beacon frame, other wireless communication devices in the same network of an MAS to be used by itself. Each of the wireless communication devices transmits the beacon frame in a vacant beacon slot with the smallest (closest to the BPST) beacon slot number in the beacon period.

That is, each of the wireless communication devices secures a MAS and a beacon slot to be used by itself on a first-come basis. In other words, a wireless communication device that joins the wireless communication network first secures its MAS and beacon slot first. This wireless communication device assigns, to other wireless communication devices, MASs and beacon slots to be used by them.

Multicast Transfer 1

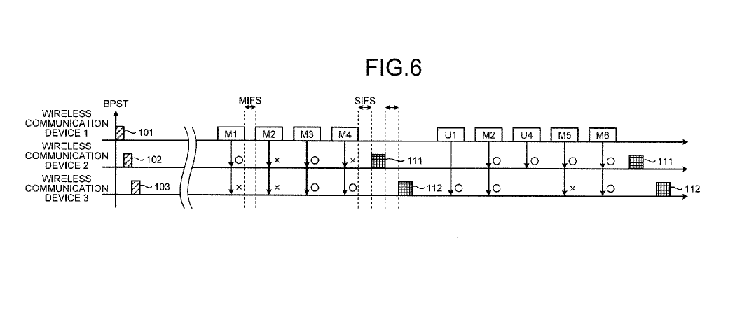

FIG. 6 is a timing chart illustrating an example of operation of burst-transferring a multicast frame in the wireless communication system according to the embodiment of the present invention.

In FIG. 6, the wireless communication device 1 is a transmitting station, and the wireless communication devices 2 and 3 are receiving stations. At the BPST, the wireless communication devices 1, 2, and 3 transmit beacon frames 101, 102, and 103 in beacon slots assigned thereto, respectively. The wireless communication device 1 designates a MAS number in which the multicast frame is transmitted, and notifies the wireless communication devices 2 and 3 of the number using the beacon frame 101.

In the MAS designated by the beacon frame, the wireless communication device 1 burst-transfers four multicast frames M1, M2, M3, and M4 at intervals of minimum inter frame space (MISS). The wireless communication devices 2 and 3 sequentially receive the multicast frames M1, M2, M3, and M4 and store therein reception results of the respective multicast frames.

In a case where ACK policy in the MAC header of a multicast frame is BACK-REQ, the wireless communication devices 2 and 3 recognize the multicast frame as the last frame in the burst transfer, and transmit back frames 111 and 112 at intervals of short inter frame space (SIFS) in the order of transmitting the beacon frames (in this case, in the order of wireless communication devices 2 and 3).

The wireless communication device 1 receives and analyzes the back frames 111 and 112 transmitted from the wireless communication devices 2 and 3, respectively. FIG. 6 shows that the wireless communication device 2 fails to receive the second multicast frame M2 and the fourth multicast frame M4, and the wireless communication device 3 fails to receive the first multicast frame M1 and the second multicast frame M2.

Accordingly, in the next (second) burst transfer, the first transmission frame is unicast-transferred to the wireless communication device 3 (U1), the second transmission frame is multicast-transferred (M2), and the fourth transmission frame is unicast-transferred to the wireless communication device 2 (U4). Also in the next (second) burst transfer, it is determined, from buffer sizes and frame count values of the back frames 111 and 112, that five frames can be transmitted. The fifth and sixth transmission frames that are not transmitted in the first burst transfer are then newly multicast-transferred (M5 and M6).

Multicast Transfer 2

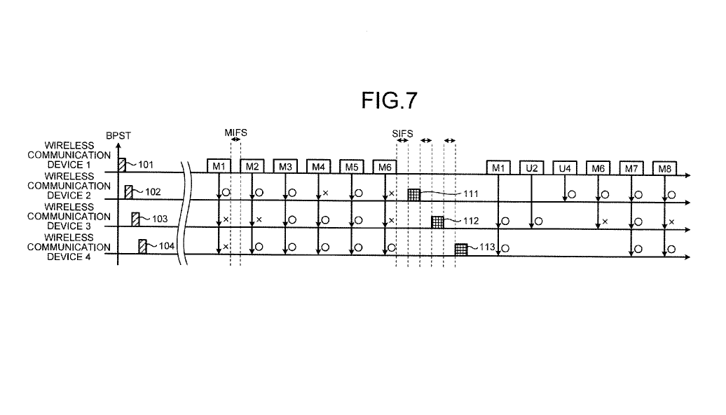

FIG. 7 is a timing chart illustrating another example of operation of burst-transferring a multicast frame in the wireless communication system according to the embodiment of the present invention.

In FIG. 7, a wireless communication device is added to the wireless communication devices belonging to a multicast group in FIG. 6. The wireless communication device 1 performs multicast transfer to the three wireless communication devices 2, 3, and 4. In FIG. 7, similarly to FIG. 6, a frame that a plurality of wireless communication devices fail to receive is retransmitted as a multicast frame. A frame that one wireless communication device fails to receive is retransmitted as a unicast frame.

At the BPST, the wireless communication devices 1, 2, 3, and 4 transmit the beacon frames 101, 102, 103, and 104 in beacon slots assigned thereto, respectively. The wireless communication device 1 designates a MAS number in which the multicast frame is transmitted, and notifies the wireless communication devices 2, 3, and 4 of the number using the beacon frame 101.

At the MAS designated by the beacon frame, the wireless communication device 1 burst-transfers six multicast frames M1, M2, M3, M4, M5, and M6. The wireless communication devices 2, 3, and 4 sequentially receive the multicast frames M1, M2, M3, M4, M5, and M6 and store therein reception results of the respective multicast frames.

In a case where ACK policy in the MAC header of a multicast frame is BACK-REQ, the wireless communication devices 2, 3, and 4 recognize the multicast frame as the last frame of the burst transfer, and transmit the back frames 111, 112, and 113 at intervals of SIFS in the order of transmitting the beacon frames (in this case, in the order of wireless communication devices 2, 3, and 4).

The wireless communication device 1 receives and analyzes the back frames 111, 112, and 113 transmitted from the wireless communication devices 2, 3, and 4, respectively. FIG. 7 shows that the wireless communication device 2 fails to receive the fourth multicast frame M4 and the sixth multicast frame M6, the wireless communication device 3 fails to receive the first multicast frame M1, the second multicast frame M2, and the sixth multicast frame M6, and the wireless communication device 4 fails to receive the first multicast frame M1.

Accordingly, in the next (second) burst transfer, the first transmission frame is multicast-transferred (M1), the second transmission frame is unicast-transferred to the wireless communication device 3 (U2), the fourth transmission frame is unicast-transferred to the wireless communication device 2 (U4), and the sixth transmission frame is multicast-transferred (M6). In the next (second) burst transfer, it is determined, from buffer sizes and frame count values of the back frames 111, 112, and 113, that six frames can be transmitted. The seventh and eighth transmission frames that are not transmitted in the first burst transfer are then newly multicast-transferred (M7 and M8).

Processing Flow of Transmitting Station

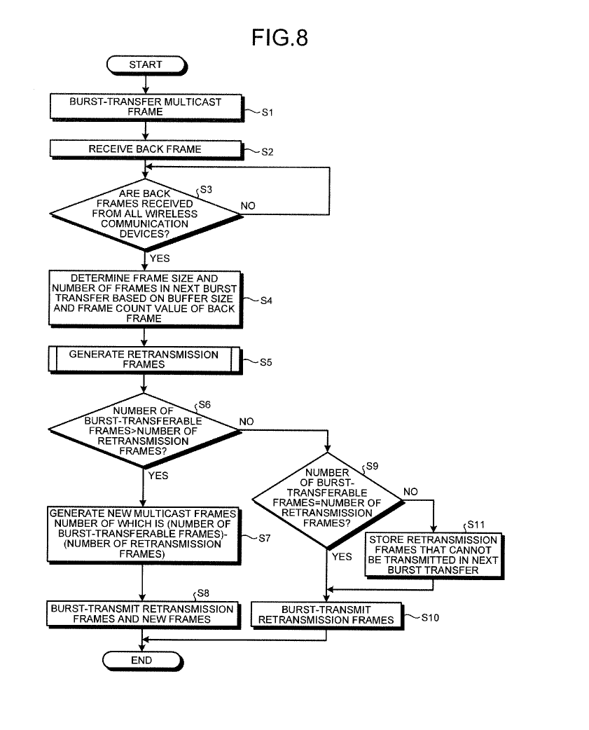

FIG. 8 is a diagram illustrating an example of a processing flow of a transmitting station in the wireless communication system according to the embodiment of the present invention.

The wireless communication device 1 serving as a transmitting station burst-transfers a multicast frame (Step S1), subsequently receives back frames from all of the wireless communication devices belonging to a multicast group (Yes at Step S2 to S3), obtains the frame count value and the minimum buffer size from the back frame, and determines the frame size (buffer size) and the number of frames of the next burst transfer that do not exceed the frame count value and the minimum buffer size (Step S4).

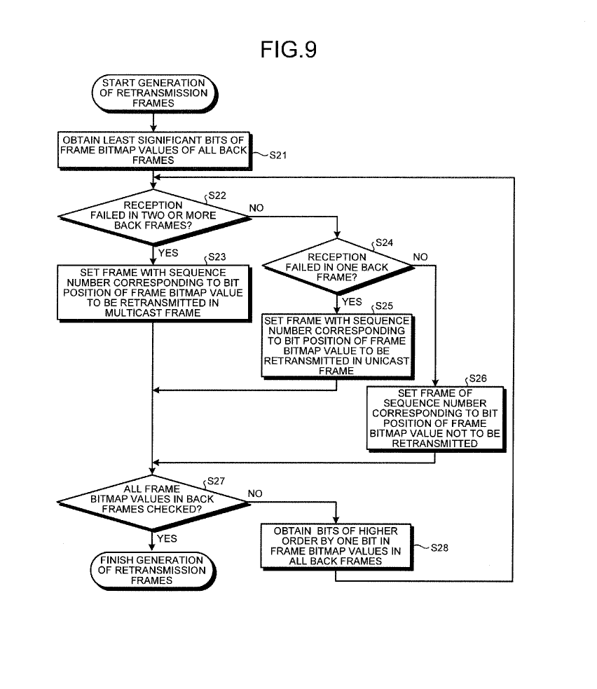

Next, a retransmission frame is generated (Step S5). Details of this step will be described later with reference to FIG. 9. The following describes transfer of the retransmission frame generated at Step S5.

In a case where the number of retransmission frames is less than the number of burst-transferable frames (Yes at Step S6), new multicast frames, the number of which is equal to a difference between the numbers of the retransmission frames and burst-transferable frames, are generated (Step S7). The retransmission frames and the new multicast frames are then burst-transmitted (Step S8). That is, the new frames are transmitted as multicast frames following the retransmission frames until their total number reaches the number of burst-transferable frames. In a case where the number of retransmission frames is equal to the number of burst-transferable frames (No at Step S6, and Yes at Step S9), all of the retransmission frames are burst-transferred (Step S10).

In a case where the number of retransmission frames is larger than the number of burst-transferable frames (No at Step S9), retransmission frames that cannot be transmitted in the next burst transfer are temporary stored (Step S11), while the rest of retransmission frames, having a transmittable size in total, are burst-transmitted (Step S10). That is, frames are burst-transferred in the ascending order of the sequence number, and the remaining retransmission frames are burst-transmitted in one after the next burst transfer.

Generation Processing of Retransmission Frame

FIG. 9 illustrates a processing flow of generating the retransmission frame (Step S5) in FIG. 8.

First, a least significant bit of a frame bitmap value of each of the back frames is obtained (Step S21).

Next, the destination address in the MAC header of a frame that a plurality of wireless communication devices fail to receive (Yes at Step S22), which is determined on the basis of the obtained bitmap value, is set to a multicast address so that a frame with a sequence number corresponding to the bit position of the frame bitmap value is retransmitted in a multicast frame (Step S23).

The destination address in the MAC header of a frame that one wireless communication device fails to receive (No at Step S22 and Yes at Step S24) is set to the address of the wireless communication device that fails to receive the frame so that a frame with a sequence number corresponding to the bit position of the frame bitmap value is retransmitted in a unicast frame (Step S25).

In a case where no wireless communication device fails to receive a frame (No at Step S24), a frame with a sequence number corresponding to the bit position of the frame bitmap value is set not to retransmitted (Step S26).

After Step S23, S25, or S26, it is determined whether all of the frame bitmap values in the back frames have been checked (Step S27). If an unchecked frame bitmap value is found (No at Step S27), a bit of higher order by one bit in the frame bitmap value in each of the back frames is obtained (Step S28), and processing proceeds to Step S22. Once all of the frame bitmap values in the back frames are checked (Yes at Step S27), generation of the retransmission frame finishes.

Processing Flow of Receiving Station

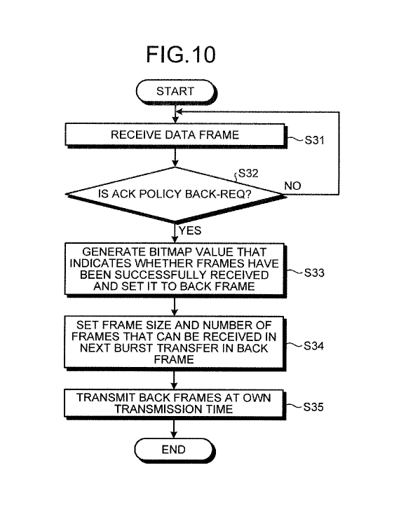

FIG. 10 is a diagram illustrating an example of a processing flow of a receiving station in the wireless communication system according to the embodiment of the present invention.

The wireless communication device serving as a receiving station determines whether ACK policy in the MAC header is BACK-REQ (Step S32), when receiving a data frame (multicast frame or unicast frame) (Step S31).

If the policy is found not to be BACK-REQ (No at Step S32), it means that the frame received is not the last frame of the burst transfer. Processing then proceeds to Step S31.

If the policy is found to be BACK-REQ (Yes at Step S32), it means that the frame received is the last frame of the burst transfer. A BACK frame is then generated which indicates whether the frames received in the burst transfer sequence are successfully received, and is set in the back frame (Step S33). In addition, the total size (buffer size) of the frames and the number of frames that can be received in the next burst transfer sequence are set in the back frame (Step S34). The wireless communication device waits until its own transmission time to transmit the back frame at intervals of SIFS in the order of transmitting beacon frames (Step S35).

As described above in detail, according to the wireless communication system of the embodiment of the present invention, the wireless communication device on the reception side transmits back frames at intervals of SIFS in the order of transmitting beacon frames immediately after receiving a burst-transferred multicast frame. Therefore, as compared to the related art in which, after receiving a burst-transferred multicast frame, the wireless communication device performs carrier sensing and transmits a response frame when a wireless band is available, the wireless communication device according to the embodiment of the present invention has a higher throughput and can immediately confirm whether the multicast frame is successfully transmitted and complete the multicast transmission.

In addition, as compared to the related art in which timing for transmitting an ACK frame corresponding to a multicast frame is given in advance, the wireless communication device on the transmission side according to the embodiment of the present invention can immediately confirm whether a multicast frame is successfully transmitted and complete the multicast transmission.

According to the embodiment, reliability of multicast transfer is improved without reducing throughput, and fast transfer can be performed in a wireless communication network including a plurality of wireless communication devices.

The present invention can be implemented in any convenient form, for example using dedicated hardware, or a mixture of dedicated hardware and software. The present invention may be implemented as computer software implemented by one or more network processing apparatus. The network can comprise any conventional terrestrial or wireless communications network, such as the Internet. The processing apparatus can compromise any suitably programmed apparatuses such as a general purpose computer, personal digital assistant, mobile telephone (such as a WAP or 3G-compliant phone) and so on. Since the present invention can be implemented as software, each and every aspect of the present invention thus encompasses computer software implemental on a programmable device. The computer software can be provided to the programmable device using any storage medium for storing processor readable code such as a floppy disk, hard disk, CD ROM, magnetic tape device or solid state memory device. The hardware platform includes any desired kind of hardware resources including, for example, a central processing unit (CPU), a random access memory (RAM), and a hard disk drive (HDD). The CPU may be implemented by any desired kind of any desired number of processor. The RAM may be implemented by any desired kind of volatile or non-volatile memory. The HDD may be implemented by any desired kind of non-volatile memory capable of storing a large amount of data. The hardware resources may additionally include an input device, an output device, or a network device, depending on the type of the apparatus. Alternatively, the HDD may be provided outside of the apparatus as long as the HDD is accessible. In this example, the CPU, such as a cache memory of the CPU, and the RAM may function as a physical memory or a primary memory of the apparatus, while the HDD may function as a secondary memory of the apparatus.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A wireless communication method in which a wireless communication device on a transmission side transmits a multicast frame to a plurality of wireless communication devices on a reception side in a wireless communication network including the wireless communication devices, the wireless communication method comprising:
transmitting beacon frames in order by the wireless communication devices;
burst-transferring a plurality of multicast frames by the wireless communication device on the transmission side; and
transmitting a response frame containing information that indicates whether each of the multicast frames is successfully received, in the order in which the beacon frames are transmitted, by the wireless communication devices on the reception side.

2. The wireless communication method according to claim 1, further comprising:
retransferring frames, wherein the wireless communication device on the transmission side transfers a frame that at least two of the wireless communication devices on the reception side fail to receive in multicast mode, and transfers a frame that one of the wireless communication devices on the reception side fails to receive in unicast mode.

3. The wireless communication method according to claim 1, wherein each of the wireless communication devices on the reception side includes information indicating number of frames that are receivable in next burst transfer, in the response frame, and the wireless communication device on the transmission side sets number of frames transmitted in the next burst transfer such that sum total of number of frames to be retransmitted and the number of frames to be transmitted in the next burst transfer is equal to or less than the number of the receivable frames.

4. A wireless communication system that includes a plurality of wireless communication devices and in which a wireless communication device on a transmission side is capable of transmitting a multicast frame to a plurality of wireless communication devices on a reception side, the wireless communication system comprising:
units that are each included in one of the wireless communication devices and each transmit a beacon frame;
units that are each included in one of the wireless communication devices and each acquire information indicating order in which the wireless communication devices transmits the beacon frame;
a unit that is included in the wireless communication device on the transmission side and burst-transfers a plurality of multicast frames; and
units that are each included in one of the wireless communication devices on the reception side and transmit response frames each containing information indicating whether each of the multicast frames is successfully received, in the order in which the beacon frames are transmitted.
